(19) United States
(12) Patent Application Publication
(10) Pub. No.: US 2017/0193485 A1
(43) Pub. Date: Jul. 6, 2017

(54) SYSTEMS AND METHODS FOR PROVIDING SMART PAYMENT OPTIONS

(71) Applicant: PayPal, Inc., San Jose, CA (US)

(72) Inventor: Yu Wu, Sunnyvale, CA (US)

(21) Appl. No.: 14/986,187

(22) Filed: Dec. 31, 2015

(51) Int. Cl. G06Q 20/22; G06Q 30/02; G06Q 20/10

(52) U.S. Cl. CPC G06Q 20/227; G06Q 20/10; G06Q 30/0226

(57) ABSTRACT

Systems, methods, and machine-readable mediums are described that provide a user with a ranked hierarchy of payment options. An example method includes receiving a request for a list of payment options associated with the user. To fulfill the request, a list of payment options associated with the user and compatible with the vendor are generated. The list of payment options is then ranked based at least in part on benefits associated with each payment option in the list. The ranked list is then provided to the vendor such that the ranked list and information about the ranking is presented to the user for selection.

### BACKGROUND

Field of the Invention

The present disclosure generally relates to providing users with advanced payment selection options in order to inform users about the maximum benefits available to them.

Related Art

When users and vendors enter into transactions, both parties may have preferences toward which payment options to use to complete the transaction. In many cases, a user's choice of a payment option is merely a default option or an option chosen at random without considering whether greater benefit could be gained by using another payment option. Likewise, vendors may have their own payment option preferences or may even wish to provide users with additional benefits for using particular payment options. Vendors, though, are usually not successful in communicating this information to users at the time when users are providing payment.

Moreover, financial institutions may also have a preference toward users using certain payment options for certain transactions or with certain vendors but are not able to communicate this preference to users since financial institutions usually do not participate in a transaction until after the user has selected a payment option and initiated payment. Thus, there is a need for providing users, vendors, and financial institutions with a way to participate in choosing a payment option for completing a transaction.

### BRIEF DESCRIPTION OF THE FIGURES

FIG. 1 is a diagram illustrating an example system for ranking payment options of a user where the components of the system are organized into functional software components.

FIG. 2 is a diagram illustrating an example payment option list and two different example results of ranking the list.

FIG. 3 is an example method embodiment for ranking payment options based on user preferences.

FIG. 4 is an example method embodiment for ranking payment options based on offers provided by financial institutions.

FIG. 5 illustrates an embodiment of a network-based system for implementing one or more processes described herein.

FIG. 6 is a diagram illustrating an example computer system that can be used to carry out the various features of the embodiments described herein.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes systems and methods for providing users with ranked payment options for completing transactions and information related to the ranking so that the user can better select a payment option.

In the following detailed description, references to “one embodiment,” “an embodiment,” “an example embodiment,” etc., indicate that the embodiment described may include a particular feature, structure, or characteristic. Every embodiment, however, may not necessarily include the particular feature, structure, or characteristic. Thus, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following detailed description refers to the accompanying drawings that illustrate example embodiments. Other embodiments are possible, and modifications can be made to the embodiments within the spirit and scope of this description. Those skilled in the art with access to the teachings provided herein will recognize additional modifications, applications, and embodiments within the scope thereof and additional fields in which embodiments would be of significant utility. Therefore, the detailed description is not meant to limit the embodiments described below.

The embodiments and accompanying figures described below generally relate to ranking payment options of a user provided by a plurality of financial institutions so that the user can make better decisions in selecting a payment option to complete a transaction. In one embodiment, payment options of a user are ranked based on the benefits associated with each payment option or by the user's preference. In another embodiment, the payment options are ranked based on preferences provided by one or more financial institutions. These embodiments are illustrated in reference to the accompanying figures as follows.

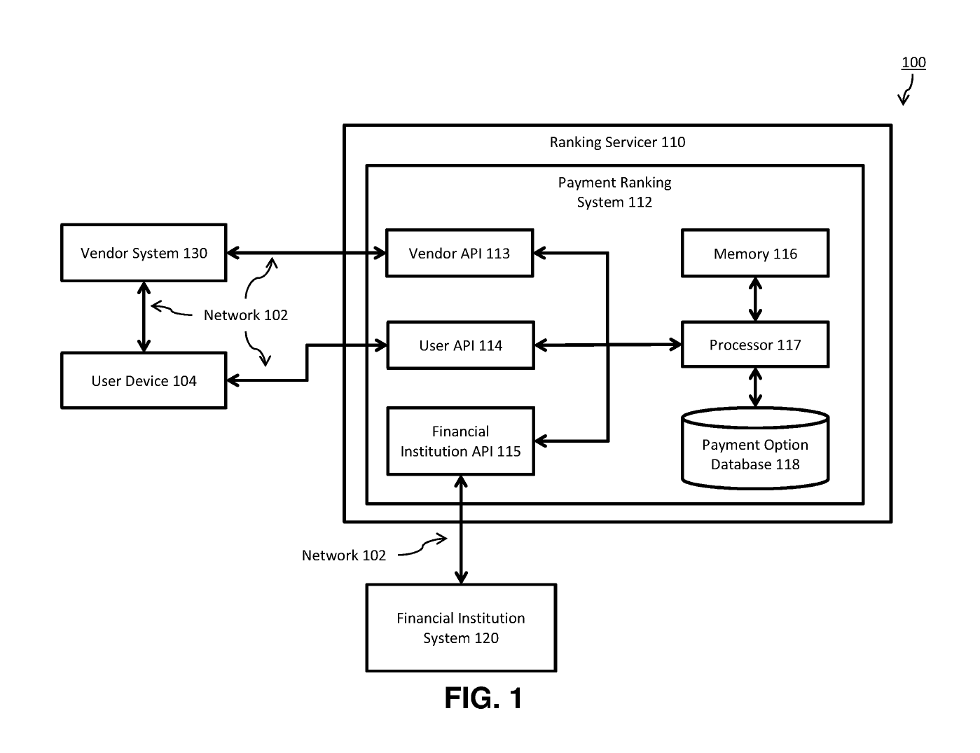

FIG. 1 is a diagram illustrating an example system 100 for ranking payment options of a user. System 100 includes a ranking servicer 110 which houses a payment ranking system 112. The ranking servicer 110 may be carried out by a financial institution or an online payment service such as, for example, PayPal, Inc. of San Jose, Calif.

The payment ranking system 112 includes payment option database 118. The payment option database 118 includes a number of user accounts where each user account can designate a number of payment options and the user's preferences for using the payment options. Each of the payment options is supported by a financial institution or by the ranking servicer 110. Supported payment options may include, for example, credit cards, debit cards, checking, savings, or brokerage accounts, or lines of credit. This list is not exclusive, though, and is not intended to limit the embodiments described herein in any way.

Each of the payment options may also be associated with a benefit or reward that is provided to the user in exchange for the user using the payment option to complete transactions for goods and services with various vendors. For example, benefits and rewards may include accumulating points that can be redeemed for cash, goods, or services such as, for example, air travel, hotel stays, or car rentals. Benefits may also include improving the status tier of the user with a vendor partner such that the user may obtain improved services from the partner. Benefits may also include a cash-back percentage or a reduced interest rate. Other types of benefits and rewards not described above are within the scope of the embodiments. Thus, the benefits and rewards described herein are not intended to limit the embodiments in any way.

Each of the benefits and rewards may also be defined by a benefit value that is broken down to a single unit of value. For example, the benefit value for a benefit based on accumulating points can be defined by a benefit value of one dollar for every 100 points accumulated. The benefit value for a benefit based on a reduced interest rate can be defined by the dollar amount saved in interest of a period of time such as, for example, one year. Other methods of determining benefit value for the different benefit types can be likewise determined. The benefit of defining benefits in terms of a single unit such as one dollar provides a uniform method of comparing different types of benefit programs.

The payment ranking system 112 also includes a number of application program interfaces including a vendor API 113, a user API 114, and a financial institution API 115. Each of these APIs facilitates communication between outside systems and the payment ranking system 112 via a network such as, for example, network 102. The network 102 may be implemented as a single network or a combination of multiple networks. For example, in various embodiments, the network 102 may include a closed, private communication network or an open network such as the Internet. Network 102 may be made up of one or more intranets, landline networks, wireless networks, cellular networks, satellite networks, and/or other appropriate types of networks. In some examples, the payment ranking system 112, the financial institution system 120, the vendor system 130, and the user device 104 may communicate through the network 102 via cellular communication, wireless communication (e.g., via a WiFi network), or any of a plurality of other radio and/or telecommunications protocols. In addition, the payment ranking system 112, the financial institution system 120, the vendor system 130, and the user device 104 may communicate through the network 102 using any one of a number of secure communication, encryption, or private messaging protocols.

The user API 114 may provide an interface between the user via user device 104 and the payment ranking system 112. Though this interface, the user may add or remove payment options or establish preferences for using various payment options. For example, a user may establish a preference for payment options that provide cash-back to the user. In this case, payment options with cash-back benefits will be ranked higher in the list of the user's available payment options. Similarly, the user may establish a preference for payment options that provide the greatest overall value. In this case, payment options may be analyzed to determine the benefit value provided by each payment option so that the payment option with the best benefit value will be ranked higher. Moreover, the user may establish multiple preferences that favor benefits where the user is close to reaching an improved tier and then cash-back. Any combination of the above preference may also be used to improve the user's experience.

The vendor API 113 may provide an interface between the payment ranking system 112 and one or more vendor systems 130. Through this interface, the vendor, with the user's permission, may interface with the payment ranking system 112 to retrieve a ranked list of the user's payment options so that the user can complete a transaction for goods or services between the user and the vendor. For example, the vendor API 113 may receive a request from the vendor system 130 for a list of payment options associated with a user engaged in a transaction with the vendor. The request may include, for example, information about the user, information about the vendor, and information about the transaction. Each piece of information may be used in various ways by the payment ranking system 112 in order to rank and return a list of payment options to the vendor system 130.

Once the request is received by the payment ranking system 112, the user's payment options are retrieved from payment option database 118. In addition to retrieving the payment options, the system may also retrieve information identifying the benefits associated with each payment option. This initial list of payment options can first be analyzed to determine which payment options are compatible with the vendor. For example, some vendors may only accept certain payment options such as credit cards from certain financial institutions or only certain forms of payments such as transfers from checking or savings accounts.

Once the initial list of compatible payment options is generated, the list can be ranked based on the benefits associated with each payment option. As discussed above, the ranking can be based on user preferences such as the payment option with the greatest benefit or the payment option that the user deems to provide the best personalized value. Further, the payment options may be ranked based on information about the transaction such as the goods or services involved in the transaction. For example, a particular payment option may provide a greater benefit for transactions involving certain vendors such as double or triple points. These payment options may be ranked higher for particular transactions despite the user's preferences.

Once the list of payment options are ranked, the list can be provided to the vendor 130 in response to the request. The list can be provided to the vendor 130 such that the list and the benefits to be gained for each payment option can be displayed to the user so that the user can easily ascertained the benefits provided by each payment option.

The financial institution API 115 may provide an interface between the payment ranking system 112 and one or more financial institution systems 120. Through this interface, financial institutions may interface with the payment ranking system 112 to provide information related to various payment options and their associated benefits. This interface may also be used to enable financial institutions to submit offers related to the user's list of payment options that can influence the ranking. For example, when a list of payment options has been generated for a user, the payment ranking system 112 may request a benefit offer from one or more financial institutions associated with the payment options in the list. The request to the financial institutions may include, for example, the user information, the vendor information, the transaction information, or a combination thereof.

The financial institutions may then respond with a benefit offer tailored to the associated payment option, the vendor, the transaction, or any combination thereof. For example, a financial institution may provide a benefit offer that doubles the points earning potential of the transaction if the vendor or the goods or services of the transaction are related to the financial institution or a partner of the financial institution. More specifically, if the transaction is for the purchase of an airline ticket, for example, the benefit offer may provide the user with additional points earned if the airline is a partner of the financial institution. Other types of benefit offers may also be made including, for example, increasing a cash-back percentage, moving up a benefit tier, or lowering an interest rate.

The benefit offer may also include a benefit for the ranking servicer 110 such as, for example, a payment that will be made to the ranking servicer 110 if the user selects the associated payment option or the ranking servicer 110 improves the rank of the payment option in the list. A combination of both types of payment may also be used where partial payment is made to the ranking servicer 110 for improving the rank of the payment option and partial payment is made if the user selects the associated payment option to complete the transaction.

The embodiment in FIG. 1 may be provided as an infrastructure (e.g., a set of APIs and UI interface) to vendors and financial institutions so that users, vendors, and financial institutions may leave implementation of the payment ranking system to the software platform, thus removing the need to develop these capabilities in-house. This means that a user, vendor, or financial institution may simply access a payment ranking service such as ranking servicer 110.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums such as, for example memory 116 that is executed by processor 117. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

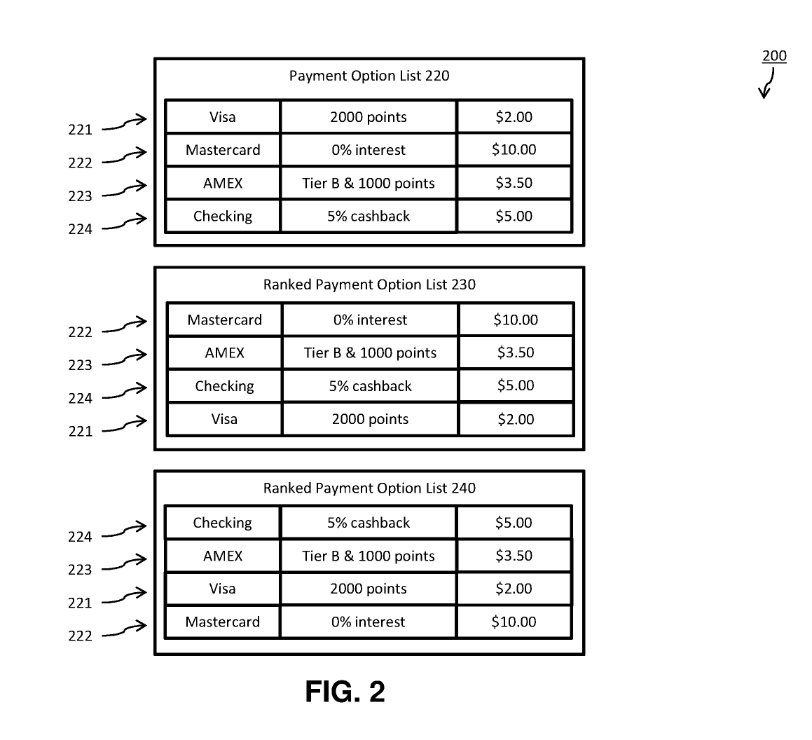

FIG. 2 is a diagram 200 illustrating an example payment option list and two different example results of ranking the list. The diagram 200 includes payment option list 220 which may be, for example, an initial payment option list generated for a user. List 220 includes a number of various types of payment options including credit cards 221, 222, and 223 and a checking account 224. Each payment option 221-224 includes a different benefit for using the payment option to complete a transaction. For example, payment option 221 includes a points benefit, payment option 222 includes a reduced interest benefit, payment option 223 includes a points and tier status benefit, and payment option 224 includes a cash-back benefit. Each of these payment options can be provided to, for example, vendor system 130 so that the user can select one of the options to complete a transaction between a user and vendor system 130.

The diagram 200 also includes a first example of a ranked payment list 230. List 230 includes the same payment options 221-224 as list 220 but the payment options are ranked according to a combination of user preferences and an offer provided by the financial institution associated with payment option 222. The result of the ranking is that payment option 222 is ranked first based on a combination of it having the best benefit value and the financial institution providing payment to the ranking servicer to boost the payment option's rank. In list 230, payment option 223 is ranked second based on a user preference (not shown) of ranking payment options higher when the user is close to achieving an improvement in a tier status. In this case, payment option 223 is ranked higher than the other options because the benefit of using payment options 223 would be the user receiving a tier improvement from tier C to tier B. Payment options 221 and 224 are then ranked according to their benefit values.

The diagram 200 includes a second example of a ranked payment list 240. List 240 also includes the same payment options as list 220 but the payment options are ranked according to different factors than list 230. For example, in list 240, payment option 224 is ranked first based on a user preference (not shown) for cash-back benefits. Thus, while payment option 224 does not provide the best benefit value, the user preference for cash-back payment options results in payment option 224 being ranked first. Payment options 223 and 221 are ranked next based on a second user preference for payment options that provide some type of positive benefit (i.e., benefits that are not related payment if interest). Payment option 222 is ranked last because of the lack of a user preference for interest rate-based benefits.

Lists 230 and 240 are provided merely as examples and are not intended to limit the embodiments described herein in any way. For example, lists 220 may be ranked based on other factors or other user preferences not shown but that might be beneficial to the user or financial institutions associated with the payment options.

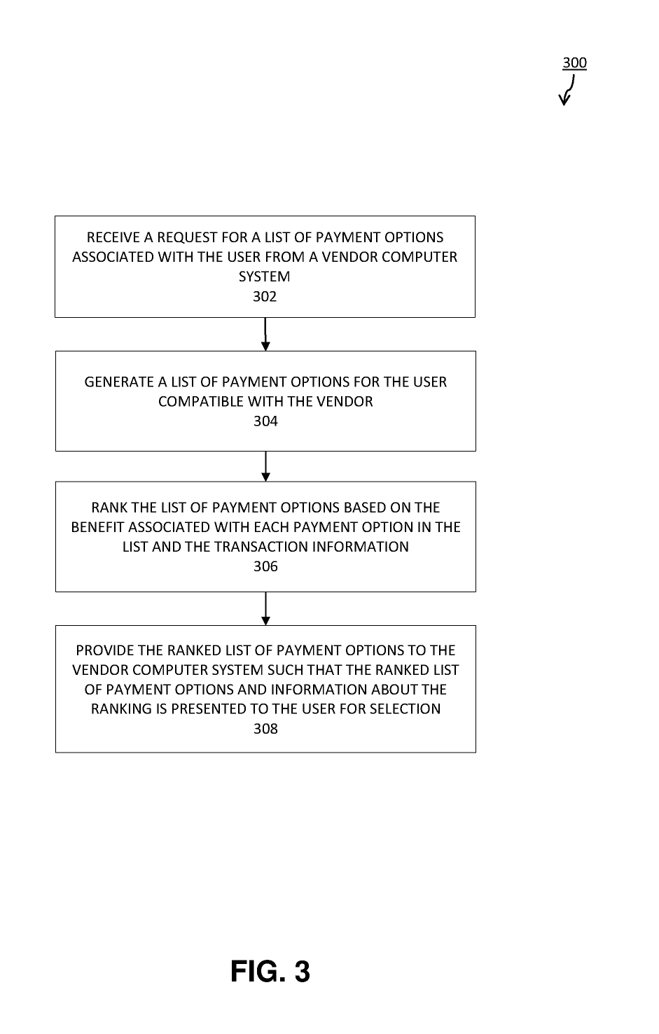

FIG. 3 is an example method 300 for ranking payment options based on user preferences. One of ordinary skill in the art in possession of the present disclosure will recognize that the method 300 may be performed by one or more payment ranking services. It will also be understood that additional steps may be performed before, during, and/or after the steps described below with reference to the method 300. Additionally, method 300 is only provided as an example and is not intended to limit the embodiments described herein.

Method 300 begins at block 302 by receiving a request for a list of payment options associated with the user from a vendor computer system. The request can include additional information such as, for example, user identification information that identifies a user, vendor information that identifies a vendor, and transaction information that identifies a transaction being processed between the vendor and the user. Block 302 may be carried out by, for example, vendor API 113 in FIG. 1.

Method 300 then proceeds to block 304 by generating a list of payment options for the user that are compatible with the vendor. Each of the payment options in the list identifies a payment method available to the user from one of a plurality of financial institutions. Moreover, one or more of the payment options is associated with a benefit provided to the user in exchange for using the payment options to process the transaction. The benefit may be of any type including, for example, points, status tiers, cash-back, reduced interest rate, or a combination thereof. Block 304 may be carried out by, for example, instructions stored in memory 116 that are executed by processor 117.

Method 300 then proceeds to block 306 by ranking the list of payment options based on the benefit associated with each listed payment option and the transaction information. As described above in reference to FIGS. 1 and 2, various factors may be used to rank the payment options such as, for example, user preferences, benefit value, vendor or transaction information, or offers provided by financial institutions. This allows the payment options to be provided to the user such that the user can know in advance the payment option that will provide the best desired benefit for a specific transaction. Block 306 may be carried out by, for example, instructions stored in memory 116 executed by processor 117.

Method 300 then proceeds to block 308 by providing the ranked list of payment options to the vendor computer system such that the ranked list of payment options and information about the ranking is presented to the user for selection. The information about the ranking may indicate why each payment option received its rank in the list as this information may be beneficial for the user to understand whether the ranking was affected by factors outside of the user's preferences. The information about the ranking may also include the potential benefit to be gained by the user for each payment option in the list so that the user can decide which payment option to use based on potential benefits to be gained. The ranked list and related information may be provided to the user as, for example, renderable text or images (e.g., XML or HTML). Block 308 may be carried out by, for example, vendor API 113 in FIG. 1.

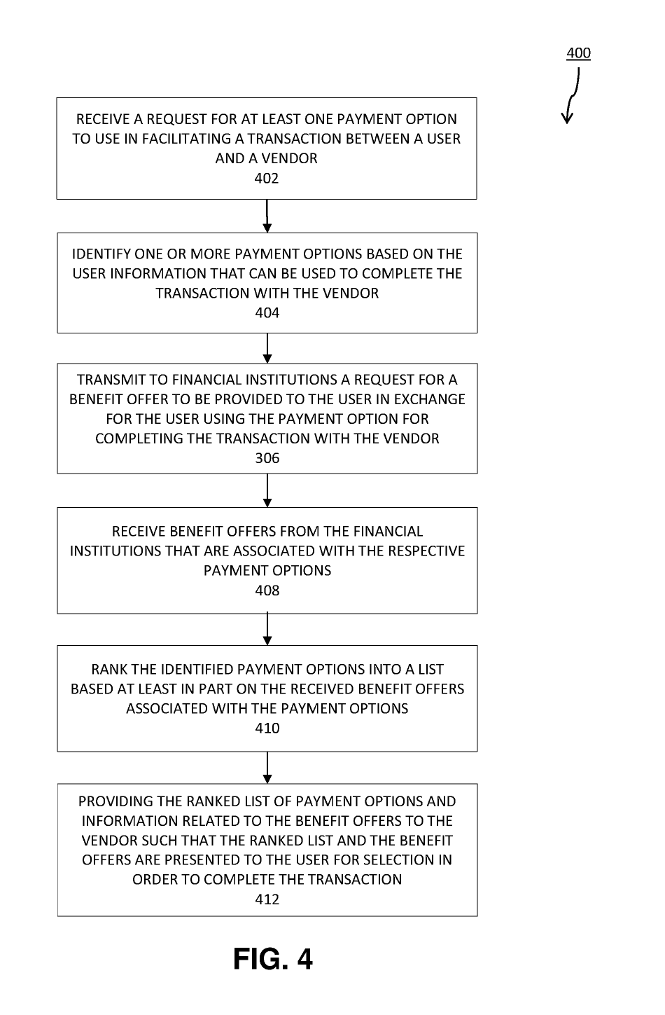

FIG. 4 is an example method 400 for ranking payment options based on one or more offers provided by financial institutions. One of ordinary skill in the art in possession of the present disclosure will recognize that the method 400 may be performed by one or more payment ranking services. It will also be understood that additional steps may be performed before, during, and/or after the steps described below with reference to the method 400. Additionally, method 400 is only provided as an example and is not intended to limit the embodiments described herein.

Method 400 begins at block 402 by receiving a request from a vendor for at least one payment option to use in facilitating a transaction between a user and a vendor. The request can include additional information such as, for example, user identification information that identifies a user, vendor information that identifies a vendor, and transaction information that identifies the transaction being processed between the vendor and the user. Block 402 may be carried out by, for example, vendor API 113 in FIG. 1.

Method 400 then proceeds to block 404 by identifying one or more payment options associated with the user that can be used to complete the transaction with the vendor based on the user information. Each payment option can identify a payment method available to a user from one of a plurality of financial institutions. Moreover, one or more of the payment options can be associated with a benefit provided to the user in exchange for using the payment options to process the transaction. The benefit may be of any type including, for example, points, status tiers, cash-back, reduced interest rate, or a combination thereof. Block 404 may be carried out by, for example, instructions stored in memory 116 that are executed by processor 117.

Method 400 then proceeds to block 406 by transmitting to one or more financial institutions associated with the identified payment options a request for a benefit offer to be provided to the user in exchange for the user using a particular payment option for completing the transaction with the vendor. Due to the various offers that each financial institution can provide, the request for offers can include additional information such as, for example, the user information, the vendor information, the transaction information, or a combination thereof. Block 406 may be carried out by, for example, financial institution API 115.

Method 400 then proceeds to block 408 by receiving one or more benefit offers from one or more of the financial institutions. The benefit offers are then associated with the payment options associated with the related financial institutions. While the benefit offers in this embodiment are requested for each ranked list, one or more generalized benefit offers may be received from financial institutions at any time and stored in a database in order to be associated with particular payment options at a future point. In this case, benefit offers may not be requested from financial institutions that have provided these generalized benefit offers. Block 408 may be carried out by, for example, financial institution API 115.

Method 400 then proceeds to block 410 by ranking the list of payment options based at least in part on the one or more of the received benefit offers associated with the payment options. As described above in reference to FIGS. 1 and 2, other various factors may also be used to rank the payment options such as, for example, user preferences, benefit value, or vendor or transaction information. This allows the payment options to be provided to the user such that the user can know in advance the payment option that will provide the best desired benefit for a specific transaction. Block 410 may be carried out by, for example, instructions stored in memory 116 executed by processor 117.

Method 400 then proceeds to block 412 by providing the ranked list of payment options and information related to the benefit offers to the vendor such that the ranked list and the benefit offers are presented to the user for selection in order to complete the transaction. The information related to the benefit offers may indicate why each payment option received its rank in the list as this information may be beneficial for the user to understand whether the ranking was affected by factors outside of the user's preferences. The information may also describe the potential benefit for a payment option before and after an associated benefit offer is applied so that the user can decide which payment option to use based on any additional benefits that may be received. The ranked list and information may be provided to the user as, for example, renderable text or images (e.g., XML or HTML). Block 412 may be carried out by, for example, vendor API 113 in FIG. 1.

While not shown in FIGS. 3 and 4, additional blocks may be added to the method without detracting from the embodiments described herein. Moreover, while methods 300 and 400 are shown as being performed in relation to system 100, methods 300 and 400 may be completed in diverse ways and not all of the blocks need be performed by the same system, system components, or at the same location. For example, the user instead of the vendor may request the ranked list of payment options such that the vendor does not access any of the user's payment options.

Thus, systems and methods have been described that provide users with intelligence about which payment option to use to complete a particular transaction. It is additionally noted that the embodiments described herein describe technological solutions to problems associated with the transaction funding (e.g., with respect to e-commerce, electronic currency, and electronic banking) that did not exist prior to the advent of computer networks and the Internet.

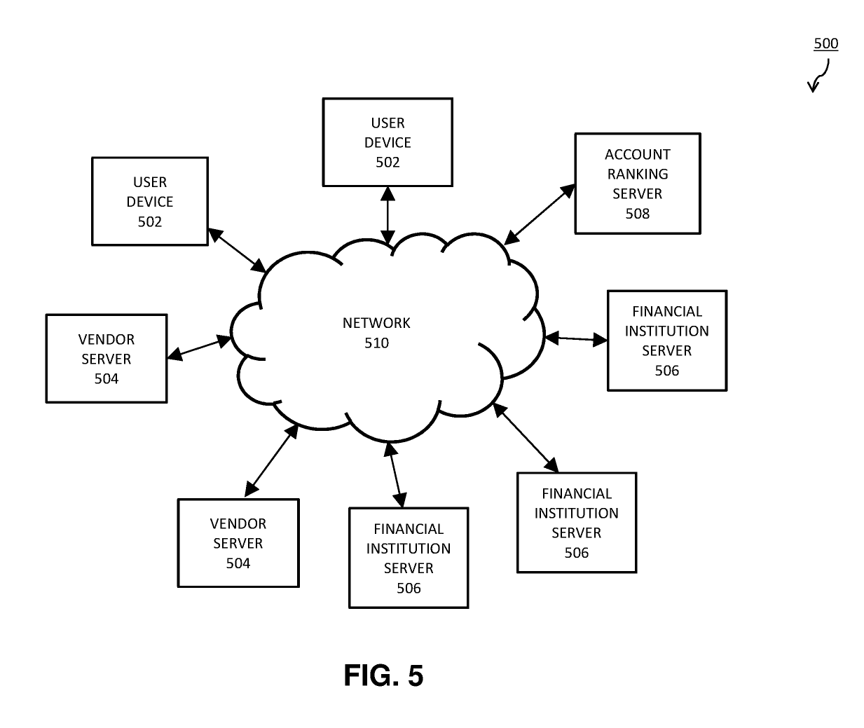

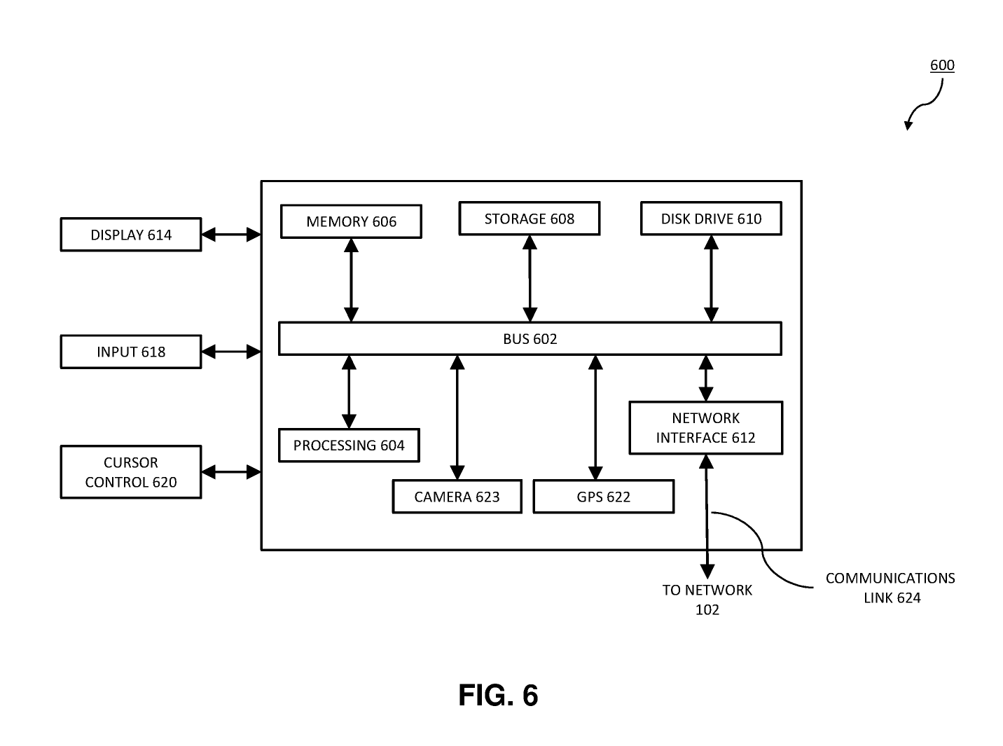

Various examples of technological devices and systems that may be used to implement embodiments of the present disclosure are discussed in more detail below with reference to FIG. 5-6.

FIG. 5 illustrates an embodiment of a network-based system 500 for implementing one or more processes described herein. The network-based system 500 may comprise a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It should be appreciated that the servers illustrated in FIG. 5 may be deployed in other ways and that the operations performed and/or the services provided by such servers may be combined or separated for a given implementation and may be performed by a greater number or fewer number of servers. One or more servers may be operated and/or maintained by the same or different entities.

The embodiment of the networked system 500 includes a plurality of user devices 502, a plurality of vendor servers 504, a plurality of financial institution servers 506, and at least one account ranking server 508. The user devices 502 may be a user computing device discussed above in FIG. 1 and may be operated by the user to communicate with either the vendor server 504 or the account ranking server 508.

The customer devices 502, vendor servers 504, financial institution servers 506, and account ranking server 508 may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of the system 500, and/or accessible over the network 102.

The network 102 may be implemented as a single network or a combination of multiple networks. For example, in various embodiments, the network 102 may include the Internet and/or one or more intranets, landline networks, wireless networks, and/or other appropriate types of networks.

The devices and servers 502-508 may be implemented using any appropriate combination of hardware and/or software configured for wired and/or wireless communication over network 102. For example, in one embodiment, the customer devices 502 may be implemented as a personal computer of a user in communication with servers 504-508 via Internet. In other embodiments, the customer devices 502 may be a smart phone, wearable computing device, laptop computer, and/or other types of computing devices.

The customer devices 502 may include one or more browser applications which may be used, for example, to provide a convenient interface to permit the customer to browse information available over the network 102. For example, in one embodiment, the browser application may be implemented as a web browser configured to view information available over the Internet.

The customer devices 502 may also include one or more toolbar applications which may be used, for example, to provide user-side processing for performing desired tasks in response to operations selected by the customer. In one embodiment, the toolbar application may display a user interface in connection with the browser application.

The customer devices 502 may further include other applications as may be desired in particular embodiments to provide desired features to the customer devices 502. In particular, the other applications may include a client-side account management software that allows customer device 502 to interface with one or more of servers 504-508 to allow a user to manage one or more accounts with the vendor, the financial institution or the account ranking service. The other applications may also include security applications for implementing user-side security features, programmatic user applications for interfacing with appropriate application programming interfaces (APIs) over the network 102, or other types of applications. Email and/or text applications may also be included, which allow customer payer to send and receive emails and/or text messages through the network 102. The customer devices 502 include one or more user and/or device identifiers which may be implemented, for example, as operating system registry entries, cookies associated with the browser application, identifiers associated with hardware of the customer devices 502, or other appropriate identifiers, such as a phone number. In one embodiment, the user identifier may be used by one or more of the servers 504-508 to associate the user with a particular account as described herein.

The financial institution servers 506 may be maintained, for example, by a conventional or on-line financial institution or entity providing financial services. In this regard, the servers 506 may include one or more databases for storing and managing user accounts and money cache accounts. The servers 506 also may include server-side application to facilitate remote management of user accounts over network 102. Financial institution servers 506 may also be one or more of the financial institution systems 120 discussed in relation to FIG. 1.

The vendor servers 504 may be housed at a vendor site or at a vendor's network service provider. Vendor servers 504 may be carried out by the vendor system 130 in FIG. 1. Account ranking server 508 may be provided by a financial institution or an online payment service provider such as, for example, PayPal, Inc. of San Jose, Calif. The account ranking server 508 may be carried out by payment option ranking system 112.

Referring now to FIG. 6, an embodiment of a computer system 600 suitable for implementing, for example, any of the systems and devices 104, 120, 130, 112, or any other computing device required by the embodiments. It should be appreciated that other devices utilizing the payment ranking system 112 discussed above may be implemented as the computer system 600 in a manner as follows.

In accordance with various embodiments of the present disclosure, computer system 600, such as a computer and/or a network server, includes a bus 602 or other communication mechanism for communicating information, which interconnects subsystems and components, such as a processing component 604 (e.g., processor, micro-controller, digital signal processor (DSP), etc.), a system memory component 606 (e.g., RAM), a static storage component 608 (e.g., ROM), a disk drive component 610 (e.g., magnetic or optical), a network interface component 612 (e.g., modem or Ethernet card), a display component 614 (e.g., CRT or LCD), an input component 618 (e.g., keyboard, keypad, or virtual keyboard), a cursor control component 620 (e.g., mouse, pointer, or trackball), a location determination component 622 (e.g., a Global Positioning System (GPS) device as illustrated, a cell tower triangulation device, and/or a variety of other location determination devices known in the art), and/or a camera component 623. In one implementation, the disk drive component 610 may comprise a database having one or more disk drive components.

In accordance with the embodiments of the present disclosure, the computer system 600 performs specific operations by the processor 604 executing one or more sequences of instructions contained in the memory component 606, such as described herein with respect to the system 112. Such instructions may be read into the system memory component 606 from another computer readable medium, such as the static storage component 608 or the disk drive component 610. In other embodiments, hard-wired circuitry may be used in place of or in combination with software instructions to implement the present disclosure.

Logic may be encoded in a computer readable medium, which may refer to any medium that participates in providing instructions to the processor 604 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 610, volatile media includes dynamic memory, such as the system memory component 606, and transmission media includes coaxial cables, copper wire, and fiber optics, including wires that comprise the bus 602. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the present disclosure, execution of instruction sequences to practice the present disclosure may be performed by the computer system 600. In various other embodiments of the present disclosure, a plurality of the computer systems 600 coupled by a communication link 624 to the network 102 (e.g., such as a LAN, WLAN, PTSN, and/or various other wired or wireless networks, including telecommunications, mobile, and cellular phone networks) may perform instruction sequences to practice the present disclosure in coordination with one another.

The computer system 600 may transmit and receive messages, data, information and instructions, including one or more programs (i.e., application code) through the communication link 624 and the network interface component 612. The network interface component 612 may include an antenna, either separate or integrated, to enable transmission and reception via the communication link 624. Received program code may be executed by processor 604 as received and/or stored in disk drive component 610 or some other non-volatile storage component for execution.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. An electronic account selection computer system for providing a user with a ranked hierarchy of payment options, comprising:
at least one network interface placing the computer system in communication with a vendor computer system;
a non-transitory memory unit for storing a plurality of software instructions and a database, the database storing information related to payment options, wherein each of the payment options identifies a payment method available to the user from one of a plurality of financial institutions and a benefit provided to the user in exchange for using the payment option for the transaction; and
at least one computer processor that executes the plurality of software instructions that causes the system to perform operations comprising:
receive a request from the vendor computer system for a list of user payment options, the request including user identification information that identifies the user, vendor information that identifies the vendor, and transaction information that identifies the transaction being processed between the vendor and the user;
generate, based on at least the vendor information and the user information, a list of payment options compatible with the vendor;
rank the list of payment options based on the benefit associated with each payment option and the transaction information; and
provide the ranked list of payment options to the vendor computer system such that the vendor computer system presents the ranked list of payment options to a user.

2. The computer system of claim 1, wherein each payment option includes information indicating a benefit type comprising points, cashback, low interest, or a combination thereof.

3. The computer system of claim 2, wherein the instructions that rank the list of payment options includes ranking the list of payment options based on the benefit type.

4. The computer system of claim 2, wherein the database further stores user preferences for the user that indicates one or more preferred benefit types.

5. The computer system of claim 4, wherein the instructions that rank the list of payment options includes retrieving user preferences associated with the user and ranking the list of payment options based on the one or more preferred benefit types indicated by the user preferences.

6. The computer system of claim 4, wherein at least one payment option includes tier information that indicates benefit tiers and the payment option's current position within the tiers.

7. The computer system of claim 6, wherein the instructions that rank the list of payment options includes analyzing the tier information for a particular payment option and ranking the list based on whether the transaction will improve the benefit tier of the payment option.

8. The computer system of claim 4, wherein the benefit type includes information describing a benefit value, wherein the benefit value describes the benefit earned per unit utilized by the payment option.

9. The computer system of claim 8, wherein the instructions that rank the list of payment options includes analyzing the benefit value for one or more payment options and ranking the list based on the greatest benefit value provided by the transaction.

10. The computer system of claim 1, wherein the instructions cause the system to perform operations further comprising:
receive, from one or more financial institutions, one or more offers, wherein the offers include information identifying one or more payment options and particular transactions or vendors to which additional benefits apply when one of the identified payment options is used for the transaction;
analyze the offers to determine whether any of the offers apply to one or more of the payment options in the list; and
wherein the instructions that rank the list of payment options includes ranking the list based, at least in part, on the offers that are determined to apply to the one or more payment options in the list.

11. A computer-implemented method for providing a user with a ranked hierarchy of payment options, comprising:
receiving, by a computer processor, a request for a list of payment options associated with the user from a vendor computer system, the request including user identification information that identifies a user, vendor information that identifies a vendor, and transaction information that identifies a transaction being processed between the vendor and the user;
generating, by a computer processor, based on the vendor information and the user information, a list of payment options associated with the user based on the user information and compatible with the vendor based on the vendor information, wherein each of the payment options in the list identifies a payment method available to the user from one of a plurality of financial institutions, and wherein one or more of the payment options is associated with a benefit provided to the user in exchange for using the payment options to process the transaction;
ranking, by a computer processor, the list of payment options based on the benefit associated with each payment option in the list and the transaction information; and
providing, by a computer processor, the ranked list of payment options to the vendor computer system such that the ranked list of payment options and information about the ranking is presented to the user for selection.

12. The method of claim 11, wherein one or more payment options are associated with a benefit type comprising one or more of points, cash-back, or reduced interest rate.

13. The method of claim 12, wherein the ranking the list of payment options includes ranking the list of payment options based on the benefit that provides the greatest value to the user.

14. The method of claim 12, wherein the database further stores user preferences for the user that indicates one or more preferred benefit types, preferred payment options, or a combination thereof.

15. The method of claim 14, wherein the ranking the list of payment options includes retrieving user preferences associated with the user and ranking the list of payment options based on the one or more preferred benefit types and preferred payment options indicated by the user preferences.

16. The method of claim 14, wherein the benefit associated with one or more payment options includes tier information that indicates benefit tiers and the payment option's current position within the tiers, and wherein the ranking the list of payment options includes analyzing the tier information for one or more payment options in the list and ranking the list based on whether the transaction will improve the tier of the payment option.

17. The method of claim 14, wherein the benefit type includes information describing a benefit value, wherein the benefit value describes the benefit earned per unit utilized by the payment option.

18. The method of claim 17, wherein the ranking the list of user accounts includes analyzing the benefit value for one or more user accounts in the list and ranking the list based on the greatest benefit value provided by the transaction.

19. The method of claim 11, wherein the method further comprises:
receiving, by a computer processor, from one or more financial institutions, one or more offers, wherein the offers include information identifying one or more payment options and particular transactions or vendors to which additional benefits apply when one of the identified payment options is used to complete the transaction;
analyzing, by a computer processor, the offers to determine whether any of the offers apply to one or more of the payment options in the list based on either the vendor information or transaction information; and
wherein the ranking the list of payment options includes ranking the list, at least in part, based on the offers that are determined to apply to the one or more payment options in the list.

20. A non-transitory machine-readable medium having stored thereon machine-readable instructions executable to cause a machine to perform operations comprising:
receiving a request for a list of account options associated with a user from a vendor computer system, the message including user identification information that identifies the user, vendor information that identifies a vendor, and transaction information that identifies a transaction being processed between the vendor and the user;
generating based on the vendor information and the user information, a list of payment options associated with the user based on the user information and compatible with the vendor based on the vendor information, wherein each of the payment options in the list identifies a payment method available to the user from one of a plurality of financial institutions, and wherein one or more of the payment options is associated with a benefit provided to the user in exchange for using the payment option to process the transaction;
receiving from one or more financial institutions, one or more offers, wherein the offers include information identifying one or more payment options and particular transactions or vendors to which additional benefits apply when one of the identified payment options is used to complete the transaction;
analyzing the offers to determine whether any of the offers apply to one or more of the payment options in the list based on either the vendor information or transaction information; and
ranking the list of payment options based at least in part on the benefit associated with the each payment option and the offers that are determined to apply to the payment options; and
providing, by a computer processor, the ranked list of payment options to the vendor computer system such that the ranked list of payment options and the information for ranking the list is presented to the user for selection.

21. An account ranking computer system for proving financial institutions priority in facilitating transactions between users and vendors, comprising:
at least one network interface placing the computer system in communication with one or more financial institution computer systems;
a database that stores a plurality of payment option, wherein each payment option identifies a payment method available to a user from one of a plurality of financial institutions;
a non-transitory memory unit for storing a plurality of software instructions; and
at least one computer processor that executes the plurality of software instructions that causes the system to perform operations comprising:
receiving a request from a vendor for at least one payment option to use in facilitating a transaction between the user and the vendor, wherein the request includes user information identifying the user, vendor information identifying the vendor, and transaction information identifying the transaction;
identifying one or more payment options associated with the user based on the user information that can be used to facilitate the transaction with the vendor;
transmitting to one or more financial institution associated with one or more of the identified payment options a request for a benefit offer to be provided to the user in exchange for the user using the payment option to complete the transaction with the vendor, wherein the request for the benefit offer includes the vendor information, the transaction information, or a combination thereof;
receiving one or more benefit offers from the one or more financial institutions that are associated with the respective payment options provided by the financial institution;
ranking the identified payment options into a list based at least in part on the one or more of the received benefit offers associated with the payment options;
providing the ranked list of payment options and information related to the benefit offers to the vendor such that the ranked list and the benefit offers are presented to the user for selection in order to complete the transaction.

22. The computer system of claim 21, wherein the instructions further causes the system to perform operations comprising:
receiving a selection from the user that indicates the payment option to be used to complete the transaction between the user and the vendor; and
after the transaction posts to the financial institution associated with the selected payment option, providing the benefit offered by the financial institution to the user.

23. The computer system of claim 21, wherein the benefit offered by the financial institutions comprises a lower interest rates, an increased number of point, an increase in the percentage of cashback on the transaction, an increase in a benefit tier, or a combination thereof.

24. The computer system of claim 21, wherein the benefit offered by the financial institution is based on the transaction including a product or service offered by the financial institution or a partner of the financial institution.

25. The computer system of claim 21, wherein the benefit offered by the financial institution is based on the vendor being the financial institution or a partner of the financial institution.

26. The computer system of claim 21, wherein at least some of the benefit offers include a benefit to the account ranking computer system.

27. The computer system of claim 26, wherein the instructions for ranking the identified payment options include ranking the payment options based on the benefit provided to the account ranking computer system.

28. The computer system of claim 26, wherein the instructions for ranking the identified payment options include ranking only the payment options associated with financial institutions that provide a benefit to the account ranking computer system.
